(19) United States
(12) Patent Application Publication
(10) Pub. No.: US 2005/0216929 A1
(43) Pub. Date: Sep. 29, 2005

(54) Disc cartridge

(75) Inventors: Kenji Hashizume, Tokyo (JP); Morimasa Sasaki, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/085,524

(22) Filed: Mar. 22, 2005

(30) Foreign Application Priority Data
Mar. 25, 2004 (JP) 2004-088429

(51) Int. Cl. G11B 23/03

(52) U.S. Cl. 720/727

(57) ABSTRACT

A disc cartridge includes a disc-shaped recording medium accommodated in a cartridge main body having a lower shell and an upper shell overlapping each other, a disc access opening formed from one outside edge part of the lower shell to a central portion thereof to expose a belt-shaped region of the disc-shaped recording medium accommodated in the cartridge main body from the central region thereof to at least the outside edge part region thereof, and a reinforcing member formed independently of the upper shell and fixed to the inner surface of the upper shell so as to cross a portion located at the outside edge part of the lower shell in the disc access opening at the position where the reinforcing member does not overlap the disc-shaped recording medium accommodated in the cartridge main body in the thickness direction thereof.

### BACKGROUND OF THE INVENTION

1. Field of the Invention

The present invention relates to a disc cartridge arranged such that a disc-shaped recording medium is accommodated in a cartridge main body having a lower shell and an upper shell.

2. Description of the Related Art

Japanese Laid-Open Patent Publication No. 2003-115181 discloses a disc recording medium device which accommodates an optical disc in a cartridge case (disc accommodation chamber) as this type of the disc cartridge. As shown in FIG. 1 of the publication, the disc recording medium device includes the cartridge case having an upper shell, an intermediate shell, and a lower shell, the optical disc accommodated in the disc accommodation chamber, and shutter members interposed between the intermediate shell and the lower shell. In this case, the intermediate shell acts as a disc tray on which the optical disc is placed and is accommodated in the disc accommodation chamber together with the optical disc so as to be sandwitched between the upper shell and the lower shell. Further, when the disc recording medium device is loaded on and unloaded from a recording/reproducing apparatus, the intermediate shell is rotated by the recording/reproducing apparatus with respect to the upper shell and the lower shell to thereby open and close a part of an opening of the lower shell. The shutter members are journaled by the intermediate shell as well as are rotated with respect to the intermediate shell when the intermediate shell rotates, thereby the shutter members open and close the opening of the lower shell together with the intermediate shell.

In contrast, the upper shell is formed in a shallow plate shape in its entirety as well as the lower shell can be attached thereto. The lower shell has the opening through which the optical disc in the cartridge case can be accessed and can be attached to the upper shell. In this case, the opening is composed of a table opening and a head opening formed continuously in the longitudinal direction of the cartridge case. With this arrangement, data can be recorded and reproduced using two optical heads at the same time through the head opening while clamping and rotating the optical disc through the table opening in the state that a rectangular region is exposed from one outside edge part to the other outside edge part confronting each other across the central hole of the optical disc accommodated in the cartridge case.

The inventors have found the following problems as a result of examination of the conventional disc recording medium device. That is, in the disc recording medium device, since data is recorded to and reproduced from the optical disc in the cartridge case using the two optical heads at the same time, the opening, through which the belt-shaped (rectangular) region can be exposed from the one outside edge part to the other outside edge part confronting each other across the central hole, is formed to the lower shell. In this case, the cartridge case used in this type of the disc recording medium device (disc cartridge) must have a certain degree of rigidity to prevent that the cartridge case is deformed by external force applied thereto when the disc cartridge is carried in, for example, a bag and the like or by force applied thereto when the disc cartridge is loaded on a recording/reproducing apparatus and thus the cartridge case or the optical disc is damaged and that the cartridge case is deformed (deflected) in the recording/reproducing apparatus and data is faultily recorded or reproduced. In contrast, it is difficult to increase the rigidity of the cartridge case by the intermediate shell and the shutter members because the intermediate shell and the shutter members are not fixed to any of the upper shell and the lower shell. Accordingly, since the upper shell is only the member that can contribute to the rigidity of the cartridge case in a portion which overlaps the opening in the thickness direction thereof, the conventional disc recording medium device is much less resistant to force for bending or twisting the cartridge case. As a result, a problem arises in that the cartridge case itself and the optical disc are damaged and that data is faultily recorded or reproduced.

In this case, it is contemplated to employ such an arrangement that the rigidity of the cartridge case is increased in its entirety by increasing the rigidity of the simple upper shell by molding it of, for example, glass-fiber-reinforced resin and the like. When, however, this arrangement is employed, the optical disc in the cartridge case cannot be visually recognized through the upper shell because the glass-fiber-reinforced resin and the like is not transparent. Therefore, the beauty of the cartridge case is spoiled as well as the design which can be employed to the cartridge case is limited to a very narrow range (design which prevents the visual recognition of the optical disc in the cartridge case) Further, it is also contemplated to employ an arrangement for increasing the rigidity of the cartridge case in its entirety by increasing the rigidity of the simple upper shell by sufficiently increasing the thickness thereof. When, however, this arrangement is employed, since the thickness of the cartridge case is increased in its entirety by the increased thickness of the upper shell, it is difficult to satisfy the standard size of the disc recording medium device defined thereto.

### SUMMARY OF THE INVENTION

A leading object of the present invention, which was made in view of the problems described above, is to provide a disc cartridge which can prevent that a cartridge main body and a disc-shaped recording medium are damaged and data is faultily recorded or reproduced due to the force applied to the cartridge main body while permitting the disc-shaped recording medium to be accessed.

To achieve the above object, a disc cartridge of the present invention includes a disc-shaped recording medium accommodated in a cartridge main body having a lower shell and an upper shell overlapping each other, a disc access opening formed from one outside edge part of the lower shell to a central portion thereof to expose a belt-shaped region of the disc-shaped recording medium accommodated in the cartridge main body from the central region thereof to at least the outside edge part region thereof, and a reinforcing member formed independently of the upper shell and fixed to the inner surface of the upper shell so as to cross a portion located at the outside edge part of the lower shell in the disc access opening at the position where the reinforcing member does not overlap the disc-shaped recording medium accommodated in the cartridge main body in the thickness direction thereof.

In the disc cartridge, the reinforcing member formed independently of the upper shell is fixed to the inner surface of the upper shell so as to cross the disc access opening at the position where the reinforcing member does not overlap the disc-shaped recording medium in the thickness direction thereof. Accordingly, there can be provided the disc cartridge including the cartridge main body which is so rigid that it can be sufficiently prevented that the cartridge main body itself and the disc-shaped recording medium are damaged when external force is applied to the cartridge main body and that data is faultily recorded or reproduced due to the damage thereof. In this case, since the reinforcing member is fixed at the position where the reinforcing member does not overlap the disc-shaped recording medium in the thickness direction of the cartridge main body, the disc-shaped recording medium moving in the cartridge main body can be prevented from coming into contact with the reinforcing member and being damaged thereby. Therefore, occurrence of faulty recording or reproducing of data due to the damaged disc-shaped recording medium can be prevented. Further, there is employed the arrangement in which the reinforcing member formed independently of the upper shell is fixed to the inner surface of the upper shell. Accordingly, the upper shell can be formed of, for example, a transparent resin material (polycarbonate in this example) as well as the reinforcing member can be formed of a highly rigid member resistant to bending and twisting (metal, fiber-reinforced resin, and the like in this example) and fixed to the upper shell, thereby the rigidity of the cartridge main body can be sufficiently increased while securing the sufficient visually recognizing property to the disc-shaped recording medium through the upper shell and permitting employment of various designs.

In this case, the disc access opening may be formed from the one outside edge part of the lower shell to the other outside edge part thereof confronting the above outside edge part across the central portion thereof, and another reinforcing member formed independently of the upper shell may be fixed to the inner surface of the upper shell so as to cross a portion located at the other outside edge part of the lower shell in the disc access opening at the position where the reinforcing member does not overlap the disc-shaped recording medium accommodated in the cartridge main body in the thickness direction thereof. With the above arrangement, there can be provided the disc cartridge including the cartridge main body which is so rigid that it can be sufficiently prevented that the cartridge main body itself and the disc-shaped recording medium are damaged when external force is applied to the cartridge main body and that data is faultily recorded or reproduced due to the damage thereof while permitting data to be recorded to or reproduced from the disc-shaped recording medium using two optical heads at the same time.

The reinforcing member may be formed of metal. With the above arrangement, there can be provided the disc cartridge including the cartridge main body which is so rigid that it can be sufficiently prevented that the cartridge main body itself and the optical disc are damaged and that data is faultily recorded or reproduced due to the damage thereof without making the disc cartridge so thick in its entirety.

The reinforcing member may be formed of fiber-reinforced resin (so-called filler resin). With the above arrangement, since the reinforcing member is lighter than the reinforcing member composed of a metal material, the weight of the disc cartridge can be reduced in its entirety while increasing the rigidity of the cartridge main body.

The reinforcing member may be fixed to the upper shell by caulking. With this arrangement, the reinforcing member can be fixed more easily in a shorter time than the arrangement for fixing the reinforcing member by, for example, screws and the like. Further, different from the arrangement for fixing the reinforcing member by an adhesive and the like, it can be prevented that a component, which is volatilized when the adhesive is dried, deposits on the surface and the like of the disc-shaped recording medium. Accordingly, the manufacturing cost of the disc cartridge can be sufficiently lowered while preventing that data is faultily recorded or reproduced due to the deposited component.

The reinforcing member may be formed in a flat shape and fixed to the upper shell such that the surface thereof is in parallel with the surface of a top plate of the upper shell. With this arrangement, there can be provided the disc cartridge including the cartridge main body having high rigidity in which the movement of the optical heads is not inhibited in the recording/reproducing apparatus.

It should be noted that the disclosure of the present invention relates to a content of Japanese Patent Application 2004-088429 that was filed on 25 Mar. 2004 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a perspective view of the outside appearance of a disc cartridge;

FIG. 2 is a cross-sectional view of the disc cartridge taken along the line C-C of FIG. 1 (capable of disc access);

FIG. 3 is a plan view of a lower shell of a cartridge main body when it is viewed from an inner surface side;

FIG. 4 is a plan view of an upper shell of the cartridge main body when it is viewed from an inner surface side;

FIG. 5 is a plan view of the upper shell in the state in which reinforcing members are fixed thereto when the upper shell is viewed from the inner surface side;

FIG. 6 is a perspective view of the outside appearance of the reinforcing members;

FIG. 7 is a cross-sectional view of the upper shell taken along the line D-D of FIG. 5;

FIG. 8 is a cross-sectional view of the reinforcing member side taken along the line E-E of FIG. 1;

FIG. 9 is a cross-sectional view of the reinforcing member side taken along the line E-E of FIG. 1;

FIG. 10 is a plan view of a disc tray when it is viewed from the lower shell side;

FIG. 11 is a plan view of shutter members when they are viewed from the lower shell side;

FIG. 12 is a cross-sectional view of a reinforcing member in another disc cartridge in the vicinity of the position where it is attached;

FIG. 13 is a cross-sectional view of a reinforcing member in still another disc cartridge in the vicinity of the position where it is attached;

FIG. 14 is a cross-sectional view of a reinforcing member in a further disc cartridge in the vicinity of the position where it is attached;

FIG. 15 is a perspective view of the outside view of a still further disc cartridge; and

FIG. 16 is a perspective view of the outside view of a yet still further disc cartridge.

### DESCRIPTION OF THE PREFERRED EMBODIMENTS

Preferred embodiments of a disc cartridge according to the present invention will be explained below with reference to the attached drawings.

First, an arrangement of the disc cartridge 1 will be explained with reference to the drawings.

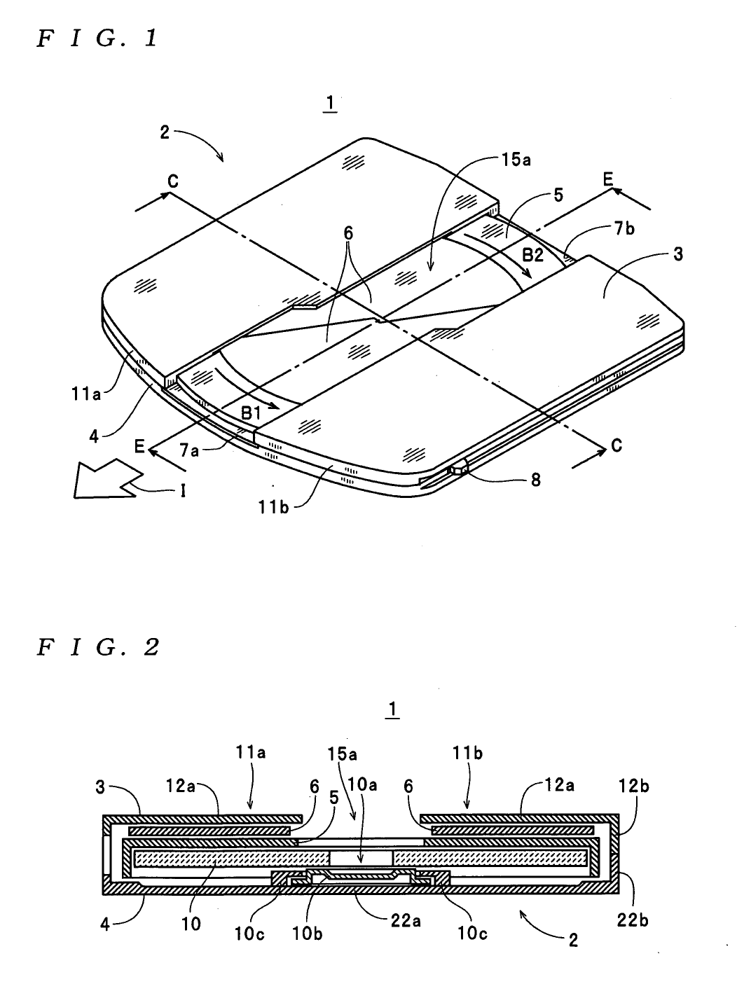

The disc cartridge 1 shown in FIGS. 1 and 2 is a cartridge type information recording medium which can record and reproduce various types of data, includes a cartridge main body 2, a disc tray 5, shutter members 6, and the like, and can accommodate an optical disc 10 therein. In FIG. 2, the disc cartridge 1 is shown thick in the thickness direction thereof with exaggeration so that the present invention can be easily understood. In this case, the optical disc 10 is, for example, a single-sided rewritable disc-shaped recording medium. As shown in FIG. 2, the optical disc 10 includes a central hole 10a having a diameter of about 15 mm and formed at the center thereof so that it is sandwitched to a recording/reproducing apparatus therethrough. The optical disc 10 is sandwitched to the recording/reproducing apparatus in such a manner that a disc-shaped clamping plate 10b attached to an upper shell 4 of the cartridge main body 2 is drawn to a lower shell 3 side by the recording/reproducing apparatus. In contrast, as shown in FIGS. 1 and 2, the cartridge main body 2 includes the lower shell 3 and the upper shell 4 which can be engaged with each other, that is, which can be overlapped each other.

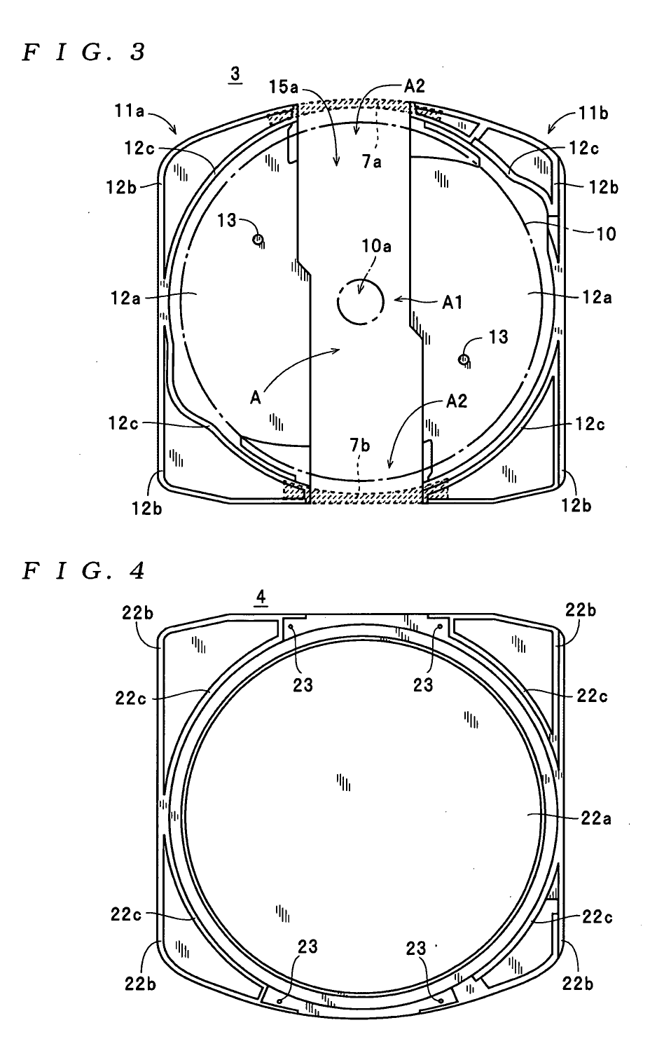

As shown in FIG. 3, the lower shell 3 includes a pair of lower shell main bodies 11a and 11b. The respective lower shell main bodies 11a and 11b are injection molded of, for example, polycarbonate (or ABS resin and the like). Specifically, each of the lower shell main bodies 11a and 11b includes bottom plates 12a, side walls 12b, and partition walls 12c. The side walls 12b are standingly provided along the outside edge part of the bottom plates 12a and constitute the side surface portions of the cartridge main body 2, and the partition walls 12c form a disc accommodating portion in the cartridge main body 2. The respective lower shell main bodies 11a and 11b are arranged such that a gap 15a is formed between the bottom plates 12a, 12a of both the lower shell main bodies 11a and 11b when respective lower shell main bodies 11a and 11b are engaged with the upper shell 4 (when respective lower shell main bodies 11a and 11b are integrated with the upper shell 4). In this case, the gap 15a forms a disc access opening (hereinafter, also referred to as “opening”) of the lower shell 3 of the present invention. The shape, the length, and the width of the opening region of the opening 15a are defined to permit the optical disc 10 in the cartridge main body 2 to be accessed (clamping executed by the recording/reproducing apparatus, irradiation of a laser beams through the optical heads, and the like) when data is recorded and reproduced.

Specifically, as shown in FIG. 3, the opening 15a is formed from one outside edge part of the lower shell 3 to the other outside edge part thereof confronting the one outside edge part across a central portion. Further, as shown in FIG. 1, the opening 15a is also formed from one outside edge part of the upper shell 4 to the other outside edge part thereof confronting the one outside edge part across a central portion. Accordingly, the opening 15a has such a shape and a size as to expose a belt-shaped region A (an example of “a belt-shaped region from the central region to at least the outside edge part regions” in the present invention) which is located between a pair of outside edge part regions A2, A2 confronting each other across a central region A1 including the peripheral portion of the central hole 10a of the optical disc 10 accommodated in the cartridge main body 2. With this arrangement, the disc cartridge 1 can record and reproduce data to and from the optical disc 10 using the two optical heads at the same time. Further, projections 13 are standingly formed on the bottom plates 12a of the lower shell main bodies 11a and 11b, respectively. The projections 13 are inserted into slits 52 (refer to FIG. 11) of the shutter members 6 and slide the shutter members 6 when the disc tray 5 is rotated as described later.

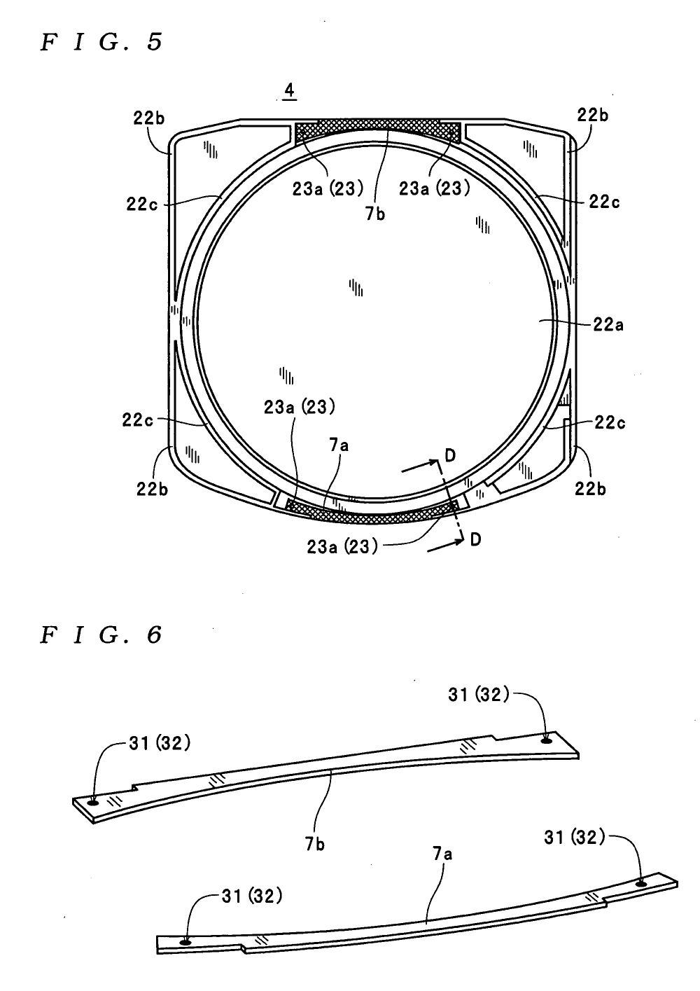

As shown in FIG. 4, the upper shell 4 has a top plate 22a, side walls 22b, and partition walls 22c. The side walls 22b is standingly provided along the outside edge part of the top plate 22a and form the side surface portion of the cartridge main body 2 together with the side walls 12b of the lower shell 3, and the partition walls 22c form the disc accommodating portion in the cartridge main body 2 together with the partition walls 12c of the lower shell 3. The upper shell 4 is injection molded of, for example, transparent polycarbonate. Further, as shown in FIG. 2, the clamping plate 10b is attached to the upper shell 4 at the central portion thereof by a ring-shaped attachment member 10c. In this case, the clamping plate 10b is attached such that it can be rotated with respect to the upper shell 4 and can slightly move in a direction in which it comes into contact with and separates from the top plate 22a. Further, as shown in FIG. 5, a pair of reinforcing members 7a and 7b are fixed to the top plate 22a.

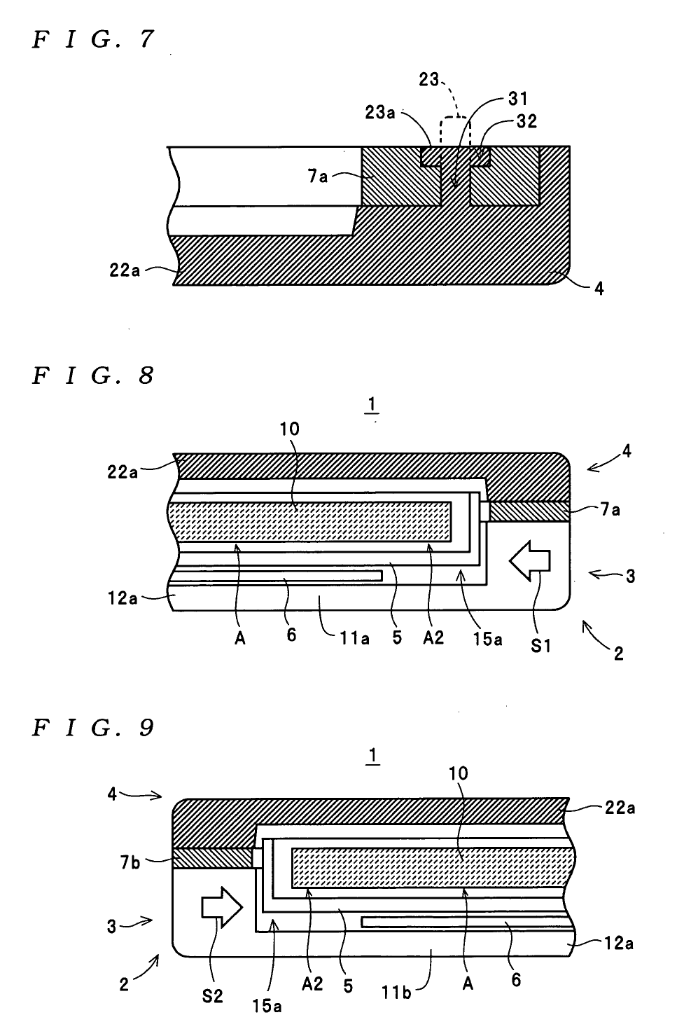

In this case, the reinforcing members 7a and 7b are formed of, for example, a stainless steel sheet having a thickness of about 1.5 mm (an example of metal in the present invention) and punched to a predetermined shape. As shown in FIGS. 6 and 7, each of the reinforcing members 7a and 7b (FIG. 7 shows only the reinforcing member 7a) has insertion holes 31, 31 formed thereto so that caulkingly fixing projections 23, 23 are inserted therethrough. Further, circular recesses 32 are formed around the opening edges of the insertion holes 31 to prevent heads 23a (refer to FIG. 7), which are formed when the extreme end parts of the fixing projections 23 are caulked, from projecting from the insertion holes 31. In this case, since the disc cartridge 1 employs the arrangement for fixing the reinforcing members 7a and 7b to the upper shell 4 by the caulking, the reinforcing members 7a and 7b can be fixed to the upper shell 4 more easily in a shorter time than the arrangement for fixing the reinforcing members 7a and 7b by, for example, screws. Further, different from the arrangement for fixing the reinforcing members 7a and 7b by an adhesive, it can be prevented that a component, which is volatilized when the adhesive is dried, deposits on the surface and the like of the optical disc 10 as well as the cartridge main body 2 can be assembled in a short time because it is not necessary to leave the reinforcing members 7a and 7b as they are until the adhesive is dried.

In the disc cartridge 1, the reinforcing members 7a and 7b are fixed such that the reinforcing members 7a and 7b cross the opening 15a formed between the lower shell main bodies 11a and 11b at the positions at both the edges of the opening 15a (the positions where the reinforcing members 7a and 7b overlap the outside edge part of the lower shell 3 (also the outside edge part of the upper shell 4)) when the lower shell main bodies 11a and 11b (lower shell 3) are engaged with (overlap) the upper shell 4 as well as the reinforcing members 7a and 7b do not overlap the optical disc 10 accommodated in the cartridge main body 2 in the thickness direction of the disc cartridge 1. In other words, the reinforcing members 7a and 7b are fixed such that the reinforcing members 7a and 7b do not overlap the optical disc 10 in plan view of the disc cartridge 1. Specifically, as shown in FIGS. 1, 8, and 9, the reinforcing members 7a and 7b are fixed so as to cross the respective portions on the front and rear end sides of the cartridge main body 2 in the loading direction thereof in the opening 15a. Further, as shown in FIG. 8, the reinforcing member 7a is fixed such that the end surface (right side surface in FIG. 8) thereof located outside of the disc cartridge 1 is flush with the side surfaces of the cartridge main body 2. Likewise, as shown in FIG. 9, the reinforcing member 7b is fixed such that the end surface (left end surface in FIG. 9) thereof located outside of the disc cartridge 1 is flush with the side surface (left side surface in FIG. 9) of the cartridge main body 2. With this arrangement, the deterioration of a visually recognizing property of the optical disc 10 through the upper shell 4 due to the existence of the reinforcing members 7a and 7b can be prevented. It should be noted that FIG. 3 shows the positions of the reinforcing members 7a and 7b of the cartridge main body 2 having been assembled by broken lines so that the positional relation between the opening 15a and the reinforcing members 7a and 7b can be easily understood.

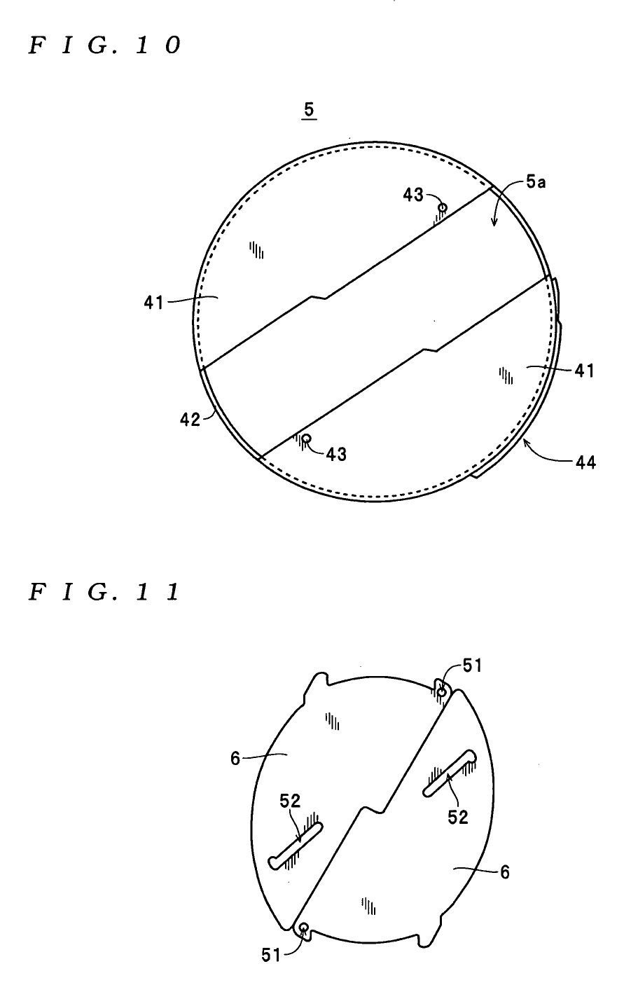

As shown in FIG. 10, the disc tray 5 is formed of a disc-shaped bottom plate 41 and a side wall 42 standingly formed around the outside edge part of the bottom plate 41 in a shallow plate shape on which the optical disc 10 can be placed. The bottom plate 41 includes an opening 5a formed thereto, and the opening 5a has a width approximately the same as that of the opening 15a formed between both the lower shell main bodies 11a and 11b of the lower shell 3. As shown in FIG. 2, the disc tray 5 is turnably accommodated in the cartridge main body 2 together with the optical disc 10. In this case, as shown in FIG. 10, projections 43, 43 are standingly formed on the lower surface (the surface on the front side in FIG. 10) of the bottom plate 41 to journal the shutter members 6. Further, the side wall 42 has a tooth portion 44 formed thereto so that a shutter open/close means (not shown) of the recording/reproducing apparatus is meshed therewith. It should be noted that, in FIG. 10, the respective teeth of the tooth portion 44 are omitted. In an ordinary state, the disc tray 5 is regulated to rotate with respect to the cartridge main body 2 by a lock member 8 (refer to FIG. 1). As shown in FIG. 11, the shutter members 6 have holes 51 formed at ends thereof so that the projections 43 of the disc tray 5 can be inserted thereinto as well as have slits 52 formed at the other ends thereof so that the projections 13 of the lower shell 3 can be inserted thereinto. As shown in FIG. 2, the shutter members 6 are accommodated in the cartridge main body 2 so as to be sandwiched between the lower shell 3 and the disc tray 5.

Next, how the disc cartridge 1 is used will be explained with reference to the drawings.

As shown in FIG. 1, when the disc cartridge 1 is unloaded from the recording/reproducing apparatus, the opening 15a of the lower shell 3 is closed by the disc tray 5 and the shutter members 6. In contrast, when the disc cartridge 1 is loaded on the recording/reproducing apparatus, the disc cartridge 1 is drawn into the recording/reproducing apparatus thereby in the direction of arrow I. It should be noted that although FIG. 1 shows the disc cartridge 1 with the lower shell 3 thereof directed upward, when the disc cartridge 1 is actually used, it is loaded on the recording/reproducing apparatus with the upper shell 4 thereof directed upward. At the time, the disc tray 5 is rotated by the shutter open/close means of the recording/reproducing apparatus, thereby the shutter members 6 are rotated with respect to the disc tray 5 so that the opening 15a is opened.

Specifically, first, when the shutter open/close means is abutted against the lock member 8, the lock member 8 is rotated with respect to the cartridge main body 2, which permits the disc tray 5 to rotate. Next, when the disc cartridge 1 is further drawn into the recording/reproducing apparatus, the shutter open/close means is meshed with the tooth portion 44 of the disc tray 5. When the disc cartridge 1 is further drawn in this state, the disc tray 5 is rotated with respect to the cartridge main body 2 in the direction of arrow B1 shown in FIG. 1. At the time, when the disc tray 5 is rotated, the shutter members 6 are rotated (slid) about the holes 51 (projections 43 of the disc tray 5). Next, when the disc cartridge 1 is further drawn into the recording/reproducing apparatus, the opening 15a of the lower shell 3 overlaps the opening 5a of the disc tray 5 in the thickness direction of the disc cartridge 1 as well as the shutter members 6, 6 are rotated and moved from the opening 5a. With this operation, the region A of the optical disc 10 is exposed to thereby permit the optical disc 10 to be accessed from the outside of the cartridge main body 2. Thereafter, since the clamping plate 10b is magnetically drawn by the recording/reproducing apparatus, the opening edge (central region A1) of the central hole 10a is sandwitched thereby, and a laser beam is irradiated through the opening 15a (data is recorded or reproduced).

In this case, as shown in FIGS. 8 and 9, since the reinforcing members 7a and 7b are fixed to the top plate 22a of the upper shell 4 in the disc cartridge 1, the surfaces (lower surfaces in the figures) of the reinforcing members 7a and 7b are located at positions higher than the surface (lower surface) of the optical disc 10. Accordingly, it is prevented that the movement of the optical head in the recording/reproducing apparatus (movement of the optical head in the directions of arrows S1 and S2 from the side thereof) is inhibited by the reinforcing members 7a and 7b. In contrast, when the disc cartridge 1, in which data has been recorded or reproduced, is taken out from the recording/reproducing apparatus, the disc tray 5 is rotated by the shutter open/close means of the recording/reproducing apparatus in the direction of arrow B2 shown in FIG. 1 so as to rotate the shutter members 6, thereby the opening 15a is closed by the disc tray 5 and the shutter members 6, 6. With this operation, the optical disc 10 in the cartridge main body 2 is protected by the cartridge main body 2, the disc tray 5, and the shutter members 6, 6.

Further, when the disc cartridge 1 in this state (the opening 15a is closed) is carried in, for example, a bag, the reinforcing members 7a and 7b fixed to the upper shell 4 prevents the cartridge main body 2 from being deformed. Specifically, in the disc cartridge 1, the reinforcing members 7a and 7b are fixed to the top plate 22a of the upper shell 4 so as to cross the opening 15a of the lower shell 3 engaged with the upper shell 4 as described above. Accordingly, the rigidity of the upper shell 4 as a simple body can be sufficiently increased by the reinforcing members 7 fixed to the top plate 22a regardless that the lower shell 3, which is composed of the lower shell main bodies 11a and 11b arranged independently, is employed. As a result, the rigidity of the cartridge main body 2 in its entirety is more increased than that the cartridge case of the conventional disc recording medium device. Accordingly even if external force for bending or twisting the cartridge main body 2 is applied thereto when it is carried in the bag and the like, the cartridge main body 2 can be prevented from being deformed (bent or twisted) as well as data can be prevented from being faultily recorded or reproduced in the recording/reproducing apparatus.

Since the reinforcing members 7a and 7b, which are formed of a stainless steel sheet independently of the lower shell 3 and the upper shell 4, are sufficiently thin, an increase in the thickness of the cartridge main body 2 is minimized while increasing the rigidity of the cartridge main body 2 in its entirety. Further, the reinforcing members 7a and 7b are fixed at the positions where the reinforcing members 7a and 7b do not overlap the optical disc 10 in the cartridge main body 2 in the thickness direction of the disc cartridge 1. Accordingly, even if the disc cartridge 1 is dropped or the cartridge main body 2 is deformed, for example, the optical disc 10 can be prevented from coming into contact with the reinforcing members 7a and 7b in the cartridge main body 2.

As described above, according to the disc cartridge 1, the reinforcing members 7a and 7b, which are formed independently of the upper shell 4, is fixed on the inner surface of the upper shell 4 so as to cross opening 15a. Accordingly, there can be provided the disc cartridge 1 including the cartridge main body 2 which is so rigid that it can be sufficiently prevented that the cartridge main body 2 itself and the optical disc 10 are damaged when external force is applied to the cartridge main body 2 and that data is faultily recorded or reproduced due to the damage thereof. In this case, since the reinforcing members 7a and 7b are fixed at the positions where the reinforcing members 7a and 7b do not overlap the optical disc 10 in the thickness direction of the cartridge main body 2, the optical disc 10 moving in the cartridge main body 2 can be prevented from coming into contact with the reinforcing members 7a and 7b and being damaged thereby. Therefore, occurrence of faulty recording or reproducing of data due to the damaged optical disc 10 can be prevented. Further, there is employed the arrangement in which the reinforcing members 7a and 7b formed independently of the upper shell 4 are fixed to the top plate 22a. Accordingly, the upper shell 4 can be formed of, for example, the transparent resin material (polycarbonate in this example) as well as the reinforcing members 7a and 7b can be formed of the highly rigid member resistant to bending and twisting (stainless steel in this example) and fixed to the upper shell 4, thereby the rigidity of the cartridge main body 2 can be sufficiently increased while securing the sufficient visually recognizing property to the optical disc 10 through the upper shell 4 and permitting employment of various designs.

The reinforcing members 7a and 7b are fixed so as to cross the opening 15a formed from the one outside edge part of the lower shell 3 to the other outside edge part thereof confronting the one edge across the central portion therebetween. As a result, there can be provided the disc cartridge 1 including the cartridge main body 2 which is so rigid that it can be sufficiently prevented that the cartridge main body 2 itself and the optical disc 10 are damaged when external force is applied to the cartridge main body 2 and that data is faultily recorded or reproduced due to the damage thereof while permitting that data is recorded to and reproduced from the optical disc 10 using the two optical heads at the same time.

According to the disc cartridge 1, the reinforcing members 7a and 7b are formed of the metal (in the example, stainless steel). Therefore, there can be provided the disc cartridge 1 including the cartridge main body 2 which is so rigid that it can be sufficiently prevented that the cartridge main body 2 itself and the optical disc 10 are damaged and that data is faultily recorded or reproduced due to the damage thereof without making the disc cartridge 1 so thick in its entirety, in other words, while satisfying the standard size defined to the disc cartridge 1.

According to the disc cartridge 1, since the reinforcing members 7a and 7b are fixed to the upper shell 4 by caulking, the reinforcing members 7a and 7b can be more easily fixed in a shorter time than an arrangement in which a method of fixing the reinforcing members 7a and 7b by screws and the like is employed as well as it is possible to prevent a volatilized component from depositing on the surface of the optical disc 10 and the like different from an arrangement in which the reinforcing members 7a and 7b are fixed by an adhesive and the like. Accordingly, the manufacturing cost of the disc cartridge 1 can be sufficiently lowered while preventing that data is faultily recorded or reproduced due to the deposited component.

According to the disc cartridge 1, the reinforcing members 7a and 7b are formed in a flat shape and fixed such that the surface thereof is in parallel with the surface of the top plate 22a of the upper shell 4. Therefore, there can be provided the disc cartridge 1 including the cartridge main body 2 having high rigidity in which the movement of the optical heads is not inhibited in the recording/reproducing apparatus.

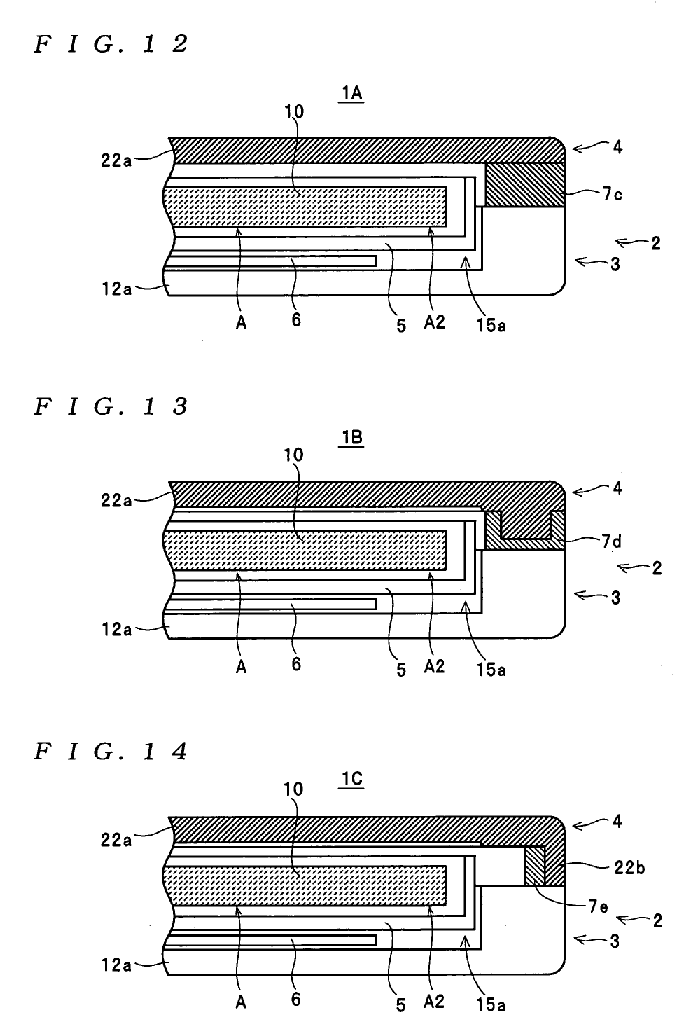

The present invention is by no means limited to the above arrangement. For example, the disc-shaped recording medium of the present invention is not limited to the rewritable optical disc 10 described above and includes not only various types of optical discs such as a reproduction-only optical disc, a write-once optical disc, and the like but also a magnet optical disc and a magnetic disc. In the above arrangement, the reinforcing members 7a and 7b are formed of the stainless steel sheet. However, the material of the reinforcing members in the present invention is not limited thereto, and fiber-reinforced resin such as glass fiber containing resin, carbon containing resin, and the like and various kinds of metal materials other than stainless steel (magnesium alloy as an example) can be used. In this case, in the arrangement in which a reinforcing member 7c formed of the fiber reinforced resin is fixed to the upper shell 4 as in, for example, a disc cartridge 1A shown in FIG. 12, since the reinforcing member 7c is lighter than the reinforcing member composed of the metal material such as stainless steel and the like, the weight of the disc cartridge 1A can be reduced in its entirety while increasing the rigidity of the cartridge main body 2.

In the disc cartridge 1, although the arrangement, in which the flat reinforcing members 7a and 7b are fixed to the upper shell 4 such that the surface thereof is in parallel with the surface of the top plate 22a, is employed, the shape of the reinforcing members 7a and 7b and the attitude thereof in which the reinforcing members 7a and 7b are attached to the upper shell 4 are not limited to those employed in the above arrangement. The rigidity of the upper shell 4 can be more increased by employing an arrangement in which a reinforcing member 7d formed in a U-shaped cross section as in, for example, a disc cartridge 1B shown in FIG. 13 or a reinforcing member formed in an L-shaped cross section (not shown) is fixed to the upper shell 4. Further, there can be also employed an arrangement in which a reinforcing member 7e formed flat is fixed to the upper shell 4 such that the surface thereof is in parallel with the side walls 22b of the upper shell 4 as in a disc cartridge 1C shown in FIG. 14. According to this arrangement, the rigidity of the upper shell 4 can be more increased similarly to the arrangements in which the reinforcing member 7d formed in the C-shaped cross section and the reinforcing member formed in the L-shaped cross section are employed.

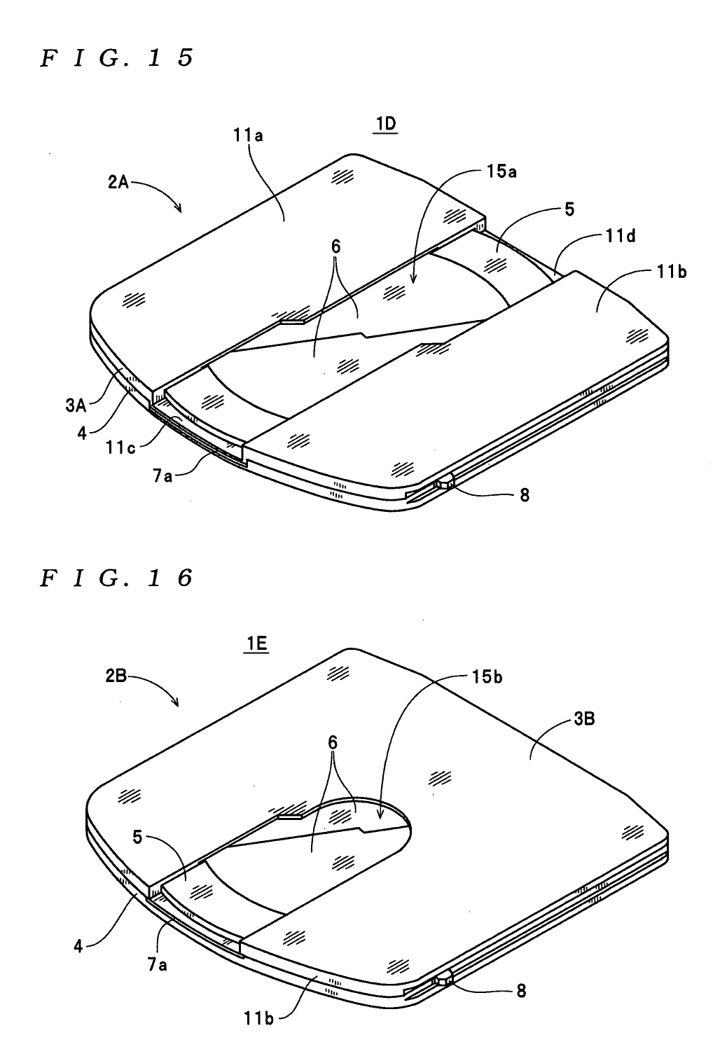

In the disc cartridge 1 described above, the cartridge main body 2 is arranged to include the lower shell 3 provided with the lower shell main bodies 11a and 11b formed independently. However, the present invention is by no means limited thereto, and a cartridge main body 2A may be arranged to employ a lower shell 3A having the lower shell main bodies 11a and 11b coupled integrally with each other through coupling portions 11c and 11d as in, for example, a disc cartridge 1D shown in FIG. 15. The shape of the disc access opening of the present invention is not limited to the rectangular shape formed long in the longitudinal direction of the cartridge main body 2 as in the above example and may be a rectangular shape long in the lateral direction of the cartridge main body or a rectangular shape long in the diagonal direction of the square cartridge main body.

The disc cartridge according to the present invention is not limited to the type in which data can be recorded or reproduced using the two optical heads at the same time and includes the type in which the disc cartridge includes a cartridge main body 2B having a lower shell 3B provided with a disc access opening 15b which permits data to be recorded and reproduced using a single optical head as in a disc cartridge 1E shown in FIG. 16. In the disc cartridge 1E arranged as described above, the shape and the size of the disc access opening 15b is defined such that the belt-shaped region from the central region Al of the optical disc 10 accommodated in the cartridge main body 2B to the outside edge part region A2 thereof in one direction can be exposed, and the reinforcing member 7a is fixed to the inner surface of the upper shell 4 so as to cross the disc access opening 15b. Accordingly, there can be provided the disc cartridge 1E including the cartridge main body 2B which is so rigid that it can be sufficiently prevented that the cartridge main body 2B itself and the optical disc 10 are damaged when external force is applied to the cartridge main body 2B and that data is faultily recorded or reproduced due to the damage thereof likewise the disc cartridge 1 described above.

Further, a method of fixing the reinforcing members to the upper shell is not limited to the method of fixing it by caulking described above, and various kinds of fixing methods using screws, adhesive, welding, and the like can be employed. Furthermore, there can be also employed an arrangement in which the reinforcing members are lockingly fixed by locking claws formed to the upper shell (not shown) and an arrangement in which the reinforcing members formed of, for example, the metal material are inserted (insert molded) when the upper shell 4 is molded (not shown).

1. A disc cartridge comprising:
a disc-shaped recording medium accommodated in a cartridge main body comprising a lower shell and an upper shell overlapping each other;
a disc access opening formed from one outside edge part of the lower shell to a central portion thereof to expose a belt-shaped region of the disc-shaped recording medium accommodated in the cartridge main body from the central region thereof to at least the outside edge part region thereof; and
a reinforcing member formed independently of the upper shell and fixed to the inner surface of the upper shell so as to cross a portion located at the outside edge part of the lower shell in the disc access opening at the position where the reinforcing member does not overlap the disc-shaped recording medium accommodated in the cartridge main body in the thickness direction thereof.

2. A disc cartridge according to claim 1, wherein the disc access opening is formed from the one outside edge part of the lower shell to the other outside edge part thereof confronting the above outside edge part across the central portion thereof, and another reinforcing member formed independently of the upper shell is fixed to the inner surface of the upper shell so as to cross a portion located at the other outside edge part of the lower shell in the disc access opening at the position where the reinforcing member does not overlap the disc-shaped recording medium accommodated in the cartridge main body in the thickness direction thereof.

3. A disc cartridge according to claim 1, wherein the reinforcing member is formed of metal.

4. A disc cartridge according to claim 1,
wherein the reinforcing member is formed of fiber-reinforced resin.

5. A disc cartridge according to claim 1,
wherein the reinforcing member is fixed to the upper shell by caulking.

6. A disc cartridge according to claim 1,
wherein the reinforcing member is formed in a flat shape and fixed to the upper shell such that the surface thereof is in parallel with the surface of a top plate of the upper shell.
